(19) United States
(12) Patent Application Publication
(10) Pub. No.: US 2010/0119341 A1
(43) Pub. Date: May 13, 2010

(54) METHOD AND APPARATUS FOR WASTE REMOVING AND HAULING

(75) Inventors: Christopher M. Flood, St. Charles, IL (US); Michael S. Fisher, Richardson, TX (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(73) Assignee: ADVANCED CUSTOM ENGINEERED SYSTEMS & EQUIPMENT CO., Carol Stream, IL (US)

(21) Appl. No.: 12/267,367

(22) Filed: Nov. 7, 2008

(51) Int. Cl. B65F 3/02; G06Q 50/00; G08G 1/01

(52) U.S. Cl. 414/406; 340/933; 705/1.1

(57) ABSTRACT

A method for removing and hauling waste has a receiving step requiring reception of a signal carrying identifying information from a waste receptacle outfitted with a signal generating means at a first location. The signal is transmitted from the first location to a data link. A subsequent data signal is transmitted to an external site. The data signal is compared against account information associated with the waste receptacle. A return data signal having a value designating an account status associated with the waste receptacle is transmitted from the external site; triggering automatic physical movement of the waste receptacle based on the value received from the external site. Another signal is received from the waste receptacle outfitted with a signal generating means at a second location. The signal is transmitted from the second location to the data link. A second data signal is transmitted to the external site. Data gleaned from the second data signal is stored in the account information associated with the waste receptacle.

### CROSS-REFERENCE TO RELATED APPLICATIONS

N/A

### FEDERALLY SPONSORED RESEARCH OR DEVELOPMENT

N/A

### TECHNICAL FIELD

The invention relates to refuse and waste removing and hauling. More particularly, the present invention relates to a method and apparatus for controlling, tracking, and monitoring movement of waste or refuse receptacles.

### BACKGROUND OF THE INVENTION

The collection and transportation of trash and recyclables from residential, commercial, industrial and large residential facilities is a major industry in the United States and throughout the civilized world. Typically, trash and recyclables are accumulated and temporarily stored in waste material receptacles such as trash cans and dumpsters. When filled, or at regularly scheduled intervals, trash and recyclables from the containers are transported for the eventual recycling, incineration and/or disposal into landfills.

Customers typically pay for trash and recyclables removal services based on the amount of trash and recyclables removed and the number of trash and recyclables pickups over a period of time. The compacting of trash and recyclables at a customer's location typically reduces the number of pickups. A successful trash and recyclables compactor is disclosed in U.S. Pat. No. 6,412,406, titled Trash Compactor and owned by Advanced Custom Engineered Systems & Equipment, Inc., Carol Stream, Ill.

These industrial, commercial and large residential bins and compactors are collected from different locations and hauled to a central location. Normally, those hauling the trash and recyclables are sent from a central location and dispatched to the different locations. In practice, paper logs or schedules document the hauler's runs (e.g., trash and recyclables to pick-up, trash and recyclables being picked-up, and trash and recyclables picked-up). The haulers are given their routes in person or over the phone. The haulers, in turn, keep in touch with the central location generally by cell phone or radio.

For large organizations this can be a very complicated task as there are many haulers and many customers needing their trash and recyclables collected, picked-up and hauled away. In addition, commercial, industrial and large residential (e.g., condos and apartment buildings) trash and recyclables compactors and balers must be monitored for maintenance and repair. This too requires time and energy for the haulers and/or representatives (of the service provider) to monitor and inspect.

It should also be recognized that these industrial, commercial and large residential bins, balers and compactors require both period maintenance and emergency demand repair services. Normally, those repairing the equipment are sent from a central location and dispatched to the different locations. In practice, paper logs or work orders document the repairperson's time (e.g., drive time, time spent performing the repairs, parts and materials used, etc.). The repair companies use a variety of management tools. For example, some are given their routes in person or over the phone. The service providers, in turn, keep in touch with the central location generally by cell phone or radio.

For large organizations this can be a very complicated to coordinate and to verify that the charges for these services are fair and accurate as there are many service providers and many customers needing their compactors, bins and balers repaired. In addition, commercial, industrial and large residential (e.g., condos and apartment buildings).

In addition, it must be recognized that trash and recyclables compactors, balers and bins must further be monitored for maintenance and repair.

Methods of improving the refuse collection are disclosed in commonly assigned and copending U.S. Patent Application Publication No. 2008-0197194 A1, published on Aug. 21, 2008; U.S. Patent Application Publication No. 2008-0198021 A1, published on Aug. 21, 2008; and U.S. Patent Application Publication No. 2008-0202357 A1, published on Aug. 28, 2008. These publications are hereby incorporated by reference as if fully set forth herein, and generally disclose systems for communicating with receptacles, etc.

One opportunity that exists with refuse removal is to improve communication between the vehicles making refuse pick-ups (emptying receptacles) and the central station or dispatcher. Currently, the dispatcher may be in contact with the vehicle via radio or telephone transmission. However, it is not cost-effective of feasible for the dispatcher to be in constant contact with every vehicle out in the field. Thus, it is impossible for the dispatcher to relay account information associated with each receptacle to a vehicle. In would be advantageous to provide such information to the vehicle to prevent pick-up and emptying of receptacles owned or managed by entities delinquent in their payment of invoices. Also, a given account may have special instructions, such as an additional oversized pick-up, for a discreet single day or event. The dispatcher currently has no way of assuring that the special instructions are provided to the vehicle in a timely manner.

Furthermore, there is on-going and growing concern in major municipalities with controlling several aspects refuse collection. For instance, citizens or users will often engage in activity with respect to refuse receptacles that violates municipal codes. Some of this is caused by simply overloading receptacles. Other times, a user may fall behind in payment of bills for removing refuse and waste, and the receptacles and surrounding areas will become over loaded with refuse. This provides a haven for vermin such as rats. It may also cause damage to the lane on which the receptacles are located.

Absent constant patrol of back lanes, municipalities often have no idea that these conditions exist until it is too late. Even when patrolling the back lanes, it is difficult to impossible to determine which receptacles belong to which owners/addresses. Finally, when a positive identification of the offending receptacle is able to be determined the process consumes so much time that the municipal employee is only able to investigate but a handful of the many violations that occur at any one time. Thus, city officials need a method that will facilitate receptacle identification while at the same time providing a simplified method of issuing citations to the proper entity responsible for the code violation.

The present invention is provided to solve the problems discussed above and other problems, and to provide advantages and aspects not provided by prior waste and refuse collection systems and apparatuses of this type. A full discussion of the features and advantages of the present invention is deferred to the following detailed description, which proceeds with reference to the accompanying drawings.

### SUMMARY OF THE INVENTION

A first aspect of the present invention is directed to an apparatus for removing and hauling waste. The apparatus comprises a waste receptacle, a vehicle, and an external site. The waste receptacle has a signal generating means for generating a data carrying signal associated with an identity of the waste receptacle. The vehicle has a first receiver, a waste bin located above a baseline, and a data link. The first receiver is alignable with the signal generating means for receiving the data carrying signal from the waste receptacle. The waste bin has a chamber and an emptying site. The data link receives the data signal from the first receiver and transmits a first signal from the vehicle to an external location. The external site is located at the external location and is in communication with the data link for receiving the first signal from the vehicle. The external site transmits a second signal back to the vehicle regarding an account status associated with the waste receptacle.

A second aspect of the invention is also directed to an apparatus for removing and hauling waste. This apparatus comprises a first receiver, a data link, a graphic interface, and a second receiver. The first receiver transmits a first signal carrying an identifier associated with a waste receptacle at a first instant in time to the data link. The data link receives the first signal and transmits a signal to an external location. The graphic interface displays information received pertaining to the waste receptacle from the external location. The second receiver is spaced apart from the first receiver and transmits a second signal carrying an identifier associated with a waste receptacle at a second instant in time after some duration from the first instant time. The data link receives the second signal carrying the identifier associated with the waste receptacle and transmits a second signal associated with the identifier to an external location indicating a physical transport of the waste receptacle from proximate the first sensor to proximate the second sensor.

A third aspect of the present invention is directed to a method for removing and hauling waste. The method comprises the steps of: (1) providing a first receiver at a mobile first location; (2) receiving a signal carrying an identifier associated with a waste receptacle using the first receiver; (3) providing a data link at the mobile first location to transmit a first data signal carrying waste receptacle identifying information from the mobile first location to a discreet second location and for receiving signals from the discreet second location; and (4) providing a graphic interface at the mobile first location to convey account information associated with waste receptacle from the discreet second location.

A fourth aspect of the present invention is directed to a method for removing and hauling waste. The method comprises the steps of: (1) receiving a signal carrying identifying information from a waste receptacle outfitted with a signal generating means at a first location; (2) transmitting the signal carrying identifying information from the first location to a data link; (3) transmitting a first data signal carrying information regarding the identity of the waste receptacle to an external site; (4) comparing the first data signal against an account information associated with the waste receptacle; (5) transmitting a return data signal having a value designating an account status associated with the waste receptacle from the external site; (6) automatically triggering physical movement of the waste receptacle based on the value received from the external site; (7) receiving the signal carrying identifying information from a waste receptacle outfitted with a signal generating means at a second location; (8) transmitting the signal carrying identifying information from the second location to the data link; (9) transmitting a second data signal carrying information regarding the identity of the waste receptacle to the external site; and (10) storing data gleaned from the second data signal in the account information associated with the waste receptacle.

Another aspect of the present invention is directed to a method for a municipality to control, track, and monitor waste or refuse receptacles. This method comprises the steps of: (1) requiring a permit for use of a waste receptacle; (2) issuing the permit associated with a discreet receptacle identifier; (3) providing a transmitter means attached to a discreet receptacle; and (4) transmitting a signal carrying data associated with the discreet receptacle identifier from the transmitter means. This aspect of the invention may further include the steps of: (1) providing a handheld receiver for receiving the signal from the transmitter means; (2) identifying a municipal code violation associated with a use of the waste receptacle; and/or (3) using the handheld receiver to automatically generate citations based on the municipal code violation.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a waste removal and hauling vehicle of the present invention;

FIG. 2 is a perspective view of the vehicle of FIG. 1 with a waste receptacle in an unloading position;

FIG. 3 is a perspective view of a second waste removal and hauling vehicle of the present invention;

FIG. 4 is a perspective view of the vehicle of FIG. 3 with a waste receptacle in a second position;

FIG. 5 is a perspective view of a third waste removal and hauling vehicle of the present invention;

FIG. 6 is a perspective view of the vehicle of FIG. 5 with a waste receptacle in a second position;

FIG. 7 is a perspective view of a fourth waste removal and hauling vehicle of the present invention;

FIG. 8 is a perspective view of the vehicle of FIG. 7 with a waste receptacle in a second position;

FIG. 9 is a front and rear perspective views of a receptacle showing placement of a communication means;

FIG. 10 is a flowchart of a method of the present invention;

FIG. 11 is a flowchart of a process of an on-board computer;

FIG. 12 is a flowchart of a process for controlling automatic receptacle emptying carried out by an on-board computer;

FIG. 13 is a flowchart of a process of a first receiver located at a first position on a waste removal and hauling vehicle;

FIG. 14 is a flowchart of a process of a second receiver located at a second position on a waste removal and hauling vehicle;

FIG. 15 is a flowchart of a communication process carried out by an on-board computer; and

FIG. 16 is a block diagram illustrating an apparatus and a method of the present invention; and

FIG. 17 is a flowchart illustrating a method by which a municipality may use principles and concepts of the present invention to control, track, and monitor waste or refuse receptacles.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

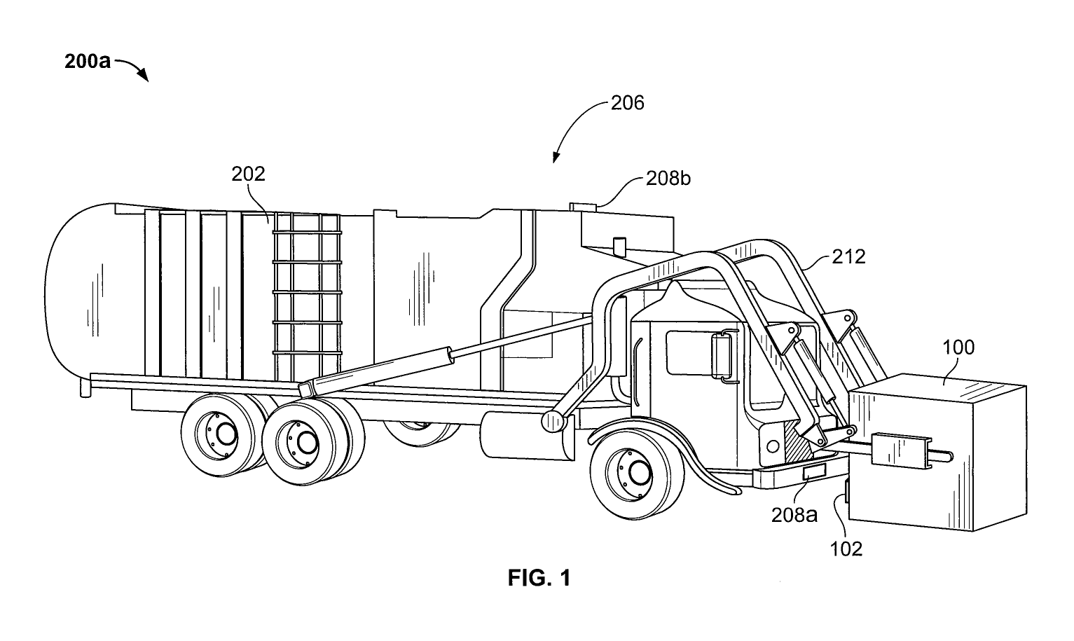

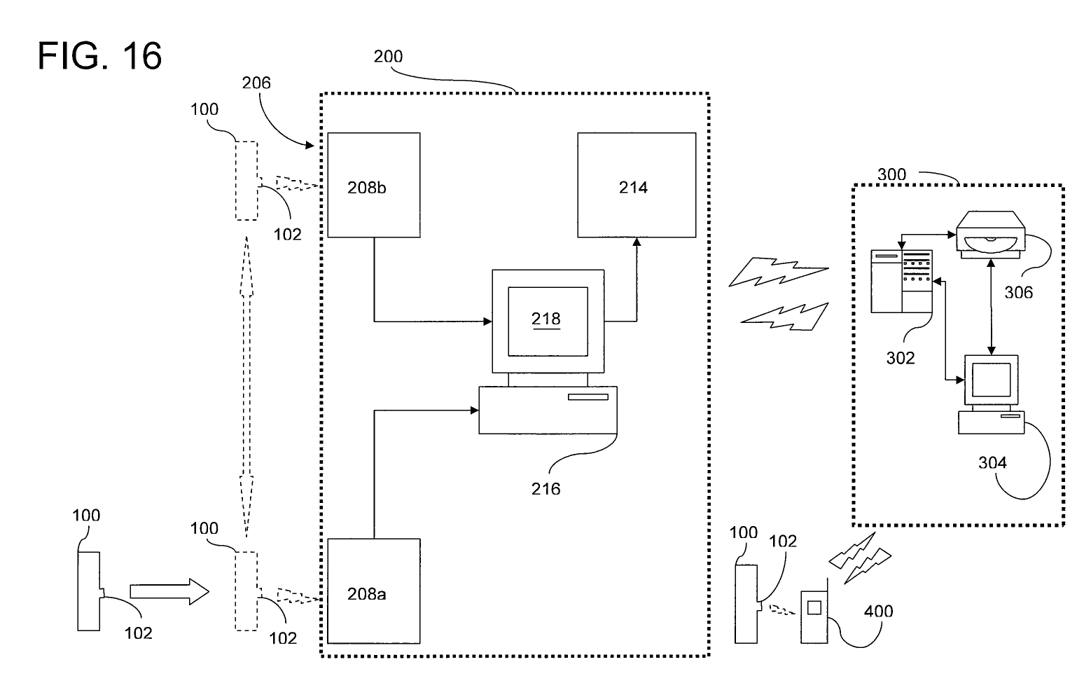

Referring to FIGS. 1-16, the present invention is directed to waste removal and hauling vehicles and systems or methods incorporating such vehicles with sensors and an operational network to facilitate proper, efficient and effective waste monitoring and collection. The inventors contemplate that the present invention will provide a means for municipalities to more effectively police violation of municipal codes in connection with commercial and residential waste collection and removal. The inventors further contemplate that the present invention will provide more effective communication between waste hauling vehicles and a dispatcher located at an external site. As best illustrated by the block diagram in FIG. 16, the overall system of the invention 10 comprises a receptacle 100, preferably a plurality of receptacles located at a plurality of locations throughout a municipality, a refuse or waste hauling vehicle 200, an external site 300, typically a central station, management office, dispatcher or the like, and a handheld reader/printer transmitter means 400 used in an example of a municipal functionality.

Each receptacle 100 is outfitted with a means of communicating or transmitting a signal carrying an identifier associated with the receptacle 102, such as a radio frequency identification (RFID) tag. RFID tags are well-known in the retail industry for identifying products. In particular, an RFID tag or transponder is an object applied to or incorporated into a product for the purpose of identification using radio waves. Most RFID tags contain at least two parts, namely an integrated circuit for storing and processing information, modulating and demodulating a (RF) signal and an antenna for receiving and transmitting the signal. RFID tags come in three general varieties: passive, active, or semi-passive (also known as battery-assisted). Passive tags require no internal power source, thus being pure passive devices (they are only activated when a reader is nearby to power them), whereas semi-passive and active tags require a power source, usually a small battery. While the present discussion focuses on passive RFID tags, it is recognized that a similar system can be used for active and semi-active RFID tags.

The RFID tags may transmit high frequency (HF) signals, low frequency signals (LF), or ultra high frequency (UHF) signals. The characteristics of these signals differ, and one particular frequency may be more advantageous than another based on the particular application of the system. For instance, low frequency signals have a short read range (distance) which would prevent errors or false reads. UHF signals can have a read range that is very short to very wide (any yards or meter).

While RFID, and in particular passive RFID tags are discussed herein, it is recognized that other identifying or alerting tags can be used. Many are known and perhaps others in the future. For example, electrical article surveillance (EAS) tags can be used. EAS tags are commonly used to prevent shoplifting from retail stores. The EAS tags are attached to merchandise and are removed or deactivated by the clerks when the item is properly bought or checked out. At the exits of stores, a detection system sounds an alarm or otherwise alerts the staff when it senses active tags. These tags are typically made of a strip of amorphous metal (metglas) having a low magnetic saturation value. This strip is also lined with a strip of ferromagnetic material with a coercive field (magnetic “hardness”). Detection is achieved by sensing harmonics and sum or difference signals generated by the non-linear magnetic response of the material under a mixture of low-frequency (in the 10 Hz to 1000 Hz range) magnetic fields.

When the ferromagnetic material is magnetized, it biases the amorphous metal strip into saturation, where it no longer produces harmonics. The tags are activated by demagnetization and deactivated with magnetization.

The identifier associated with the receptacle is preferably a discreet identifier which is assigned to the receptacle 100. The identifier information is stored on a database typically located at the external site 300, and electronically joined with an account to which the receptacle 100 belongs. In other words, account information is housed on a database located at the external site 300. Each account has one or more receptacle identifiers associated with it, and the database carries with it information typical to the management of any business account, for example, special instructions, accounts receivable, last receipt, last invoice, amount in arrears, days since last payment, historical account information, contact information, owner, etc.

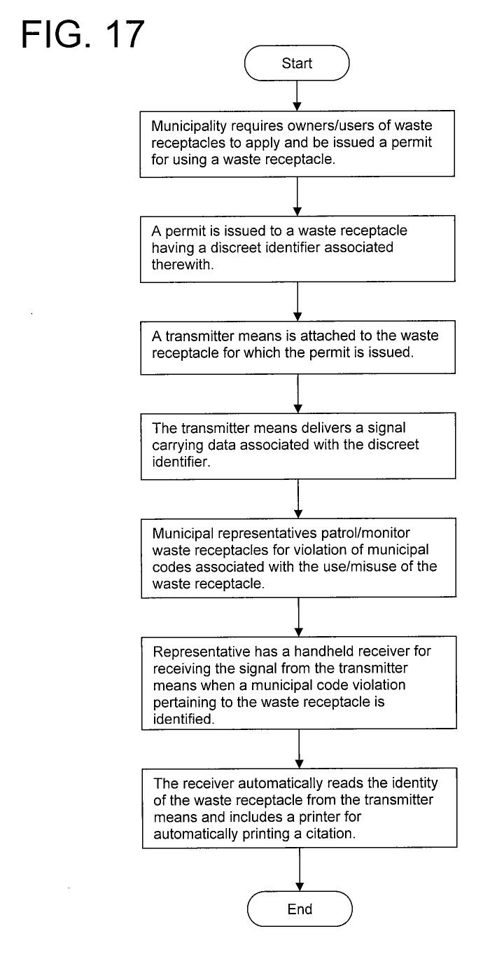

As illustrated in FIG. 17, the inventors also foresee the means for communicating or transmitting 102 as being supplied by municipalities on a permit basis to citizens. This would provide several advantages. First, the permit process would provide an unexpected source of income to the municipality because the typical permit granting process comes with an associated government fee. Secondly, it would provide a means by which the municipality can easily track ownership of or responsibility for the receptacle. Thirdly, because ownership of the receptacle would be stored on the database created during the permit process, citations for misuse, neglect, damage, etc. can be easily, swiftly, and electronically generated using a handheld receiver with printer for generating citations, providing yet a further stream of income to municipalities as well as improving lane conditions, thus reducing the likelihood of infestation by vermin. In addition, sanitation inspectors would be more productive due to the automation provided by the handhelds readers in combination with the communication means, preferably RFID tags.

As set forth above, this aspect of the invention directly results in cleaner streets and alleys. The invention will eliminate or reduce trash overages, under size containers, poor container maintenance condition, e.g. no lid. Permits and citations will force compliance. Users can specify correct container size, schedule additional pick-ups. Service may be halted due to lack of payment or by schedule.

Information regarding each permit/receptacle identifier, the account associated therewith, and the entity responsible for the account/permit/receptacle is stored on a managed database. The database may include other information such as hauler name, permit number and container asset number (human readable sticker and RFID tag). Use and access of the database is explained in more detail below.

The RFID tags can be read by inspectors having mobile and/or handheld computers 400. Citations may be issued immediately via printer on the handheld 400 and/or mailed with back-up violation data. Inspectors and other municipal employees use mobile handheld RFID readers with cameras to read tags and report violations. Citations can be issued and wireless transmission of data achieved through the handhelds 400.

This aspect of the invention requires haulers or receptacle owners to purchase annual container permits. The issued permit includes a means for transmitting, such as an RFID container tag. Revenue to the municipality is generated by an enforcement program.

Further, a container registration fee includes RFID tagging. The RFID tag information is linked to customer and hauler information in the database.

Referring to FIG. 1-8, various vehicles 200a-d used in conjunction with the system 10 of the invention are illustrated. These vehicles 200a-d are intended to be examples of the types of waste removing and hauling vehicles used to transport refuse today, and the broad aspects of the invention should not be limited to the specific examples unless otherwise claimed. It should also be understood that the vehicles 200a-d and related concepts of the external site 300 and the receptacle 100 can be used alone or, more importantly, in combination with the municipal permitting concepts described above

Each of the vehicles 200a-d includes a waste bin 202 located above a baseline upon which the vehicle 200a-d is supported, generally the ground. The waste bin 202 includes a chamber 204 and an emptying site 206. The refuse within the receptacles 100 is loaded into the chamber 204 via the emptying site 206. One of ordinary skill in the art of waste hauling would readily understand this method of refuse handling without further description as it is the standard procedure employed in the art.

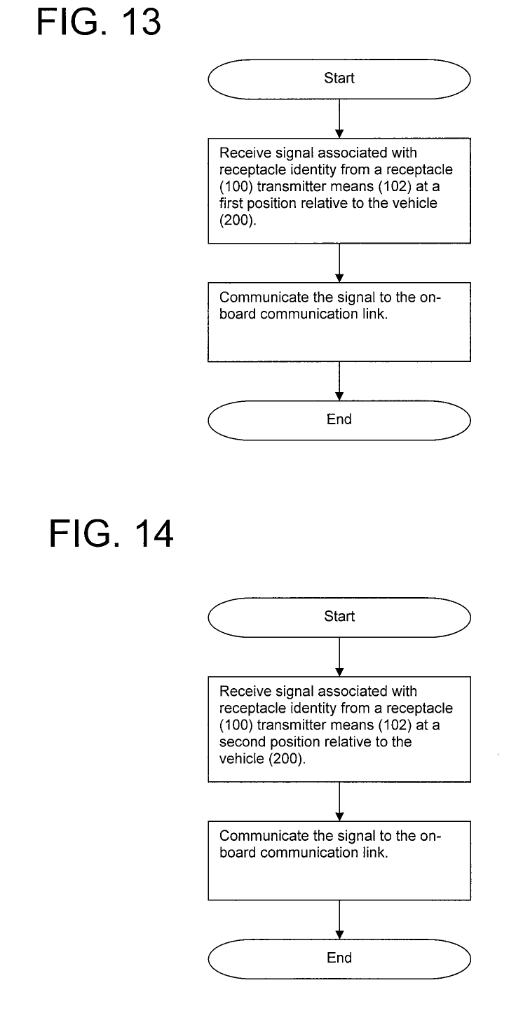

The vehicles 200a-d are further outfitted with at least one receiver 208a, in most cases a plurality of receivers 208a,b and preferably two. The receivers 208a,b may be sensors, transducers, or antennae, or any combination thereof. As illustrated in FIGS. 13 and 14, preferably, the receivers 208 receive the signal from the transmitting means 102 on the receptacles 100 and send a corresponding signal via wire, wireless, or any other medium to an on-board communication or data link 210. The signal from the receiver 208a,b may be response signal to the energy in the form of the signal transmitted by the transmitter means 102, or the signal may simply be a pass through signal, including conversion from a wireless signal to a signal carried by another medium such as a wire. In either case, all or a part of the signal from the receivers 208 to the data link are associated with the actual identity or the discreet identifier associated with the each receptacle 100. In the case where a separate response signal to the transmitter means 102 is generated, the response signal may carry additional information such as location of the particular receiver 208a,b generating the signal, etc.

The locations chosen for the receivers 208a,b are extremely important because the receivers 208a,b are used for several different purposes, including for possible tracking of the receptacle 100 as it is transferred from position-to-position relative to the vehicle 200a-d by a means for transferring the receptacle 212, which may be automated systems known in the art, as shown in FIGS. 1-8, comprising mechanical arms, booms, or the like extending outwardly from the vehicle 200 to which a waste receptacle 100, or a waste bin 202 in the case of a roll-off vehicle 200d r or manual systems also known in the art. For instance, in a conventional refuse collection and hauling vehicles 200a-d illustrated in FIGS. 1-8, a first receiver 208a is located at a position where reception of the signal from the transmitter means 102 can be promoted prior to unloading or emptying of the receptacle. As shown in the FIGS. 1-8, the first location or position is typically where the receptacle 100 is engaged by the means for transferring the receptacle 212 prior to the receptacle 100 being transported to the emptying site 206 by the means for transferring 212.

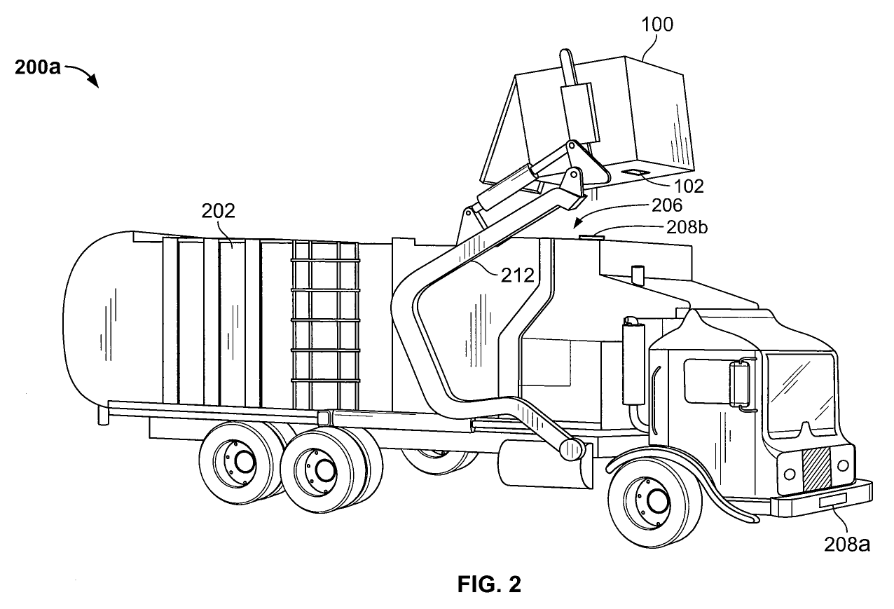

The preferred location of the first receiver 208a on a front loading vehicle 200a, illustrated in FIGS. 1 and 2, is on the front of the vehicle 200a below the windshield and centered between opposing ends or sides. The first receiver 208 may be recessed or spaced from the bumper such that accidental collision with an obstacle would not damage the receiver. Accordingly, the first receiver 208a may be located within or protected by the shell of the vehicle 200a as long as the receiver 208a is capable of achieving its purpose. One example of such a location may be behind the vehicle radiator grill. In any event, the first receiver 208a is associated with the means for transferring the receptacle 212 when the receptacle is in a first position. As illustrated, the means for transferring 212 comprises a pair of arms with grasping hooks for engaging corresponding handles on the receptacle 100.

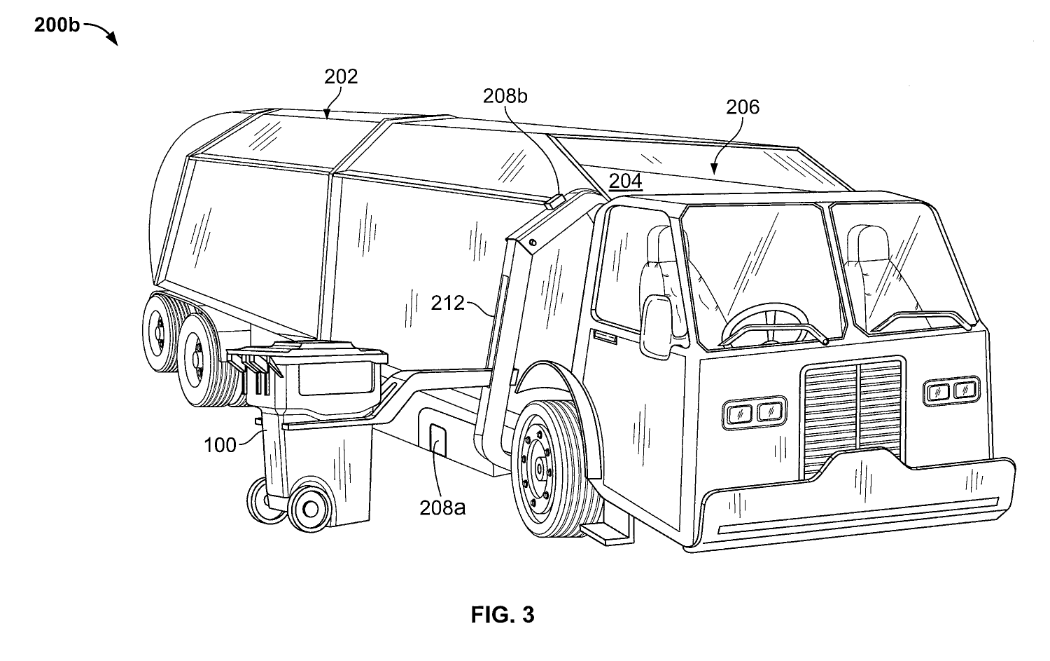

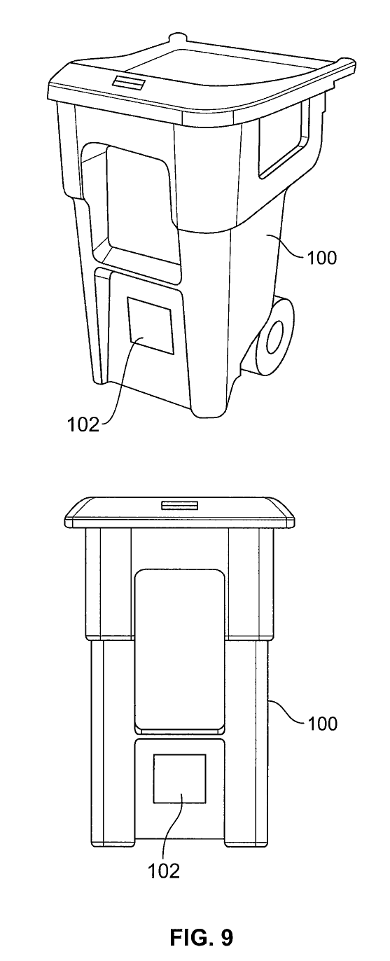

FIGS. 3-6 show vehicles emptying a certain type of receptacle 100. This type of receptacle 100 is illustrated in FIG. 9 to show a placement position for the communication means 102 which may not be evident from FIGS. 3-6.

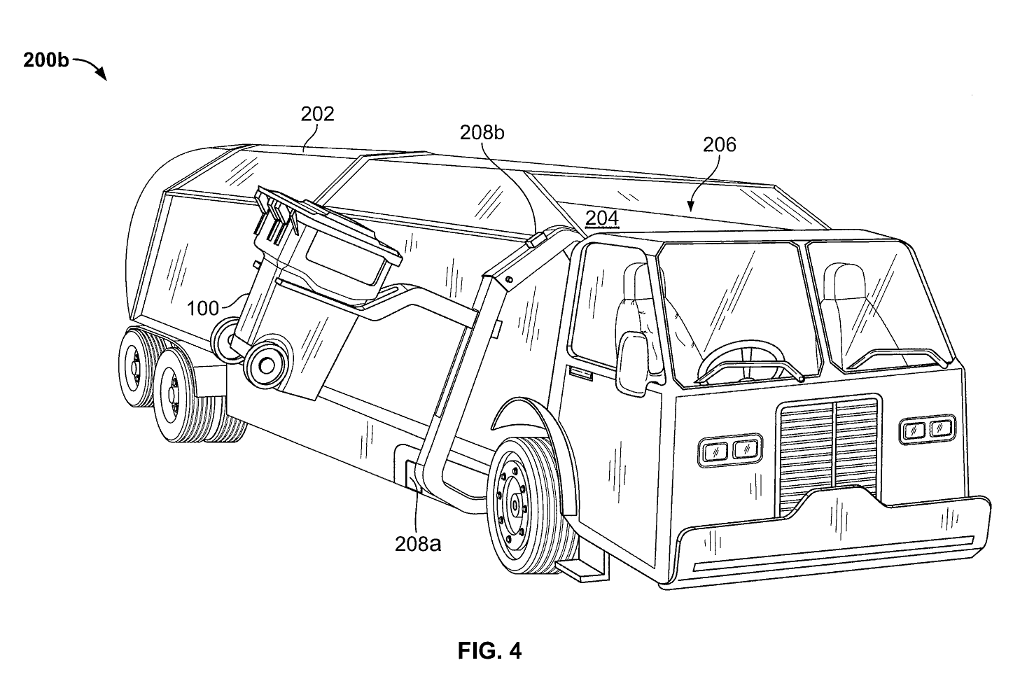

The preferred location for the first receiver 208a on a side loading vehicle 200b, illustrated in FIGS. 3 and 4, is on a side of the vehicle corresponding to a side of the vehicle where the receptacle 100 would be located prior to or just as the means for transferring the receptacle 212 engages the receptacle 100. This location is typically on the passenger side adjacent the transfer means 212. This includes either just behind the cab or on the cab to the rear of the passenger side door. The first receiver 208a may be protected by locating on the passenger side and behind the cab, such that the receiver is protected by the cab and the waste bin 202.

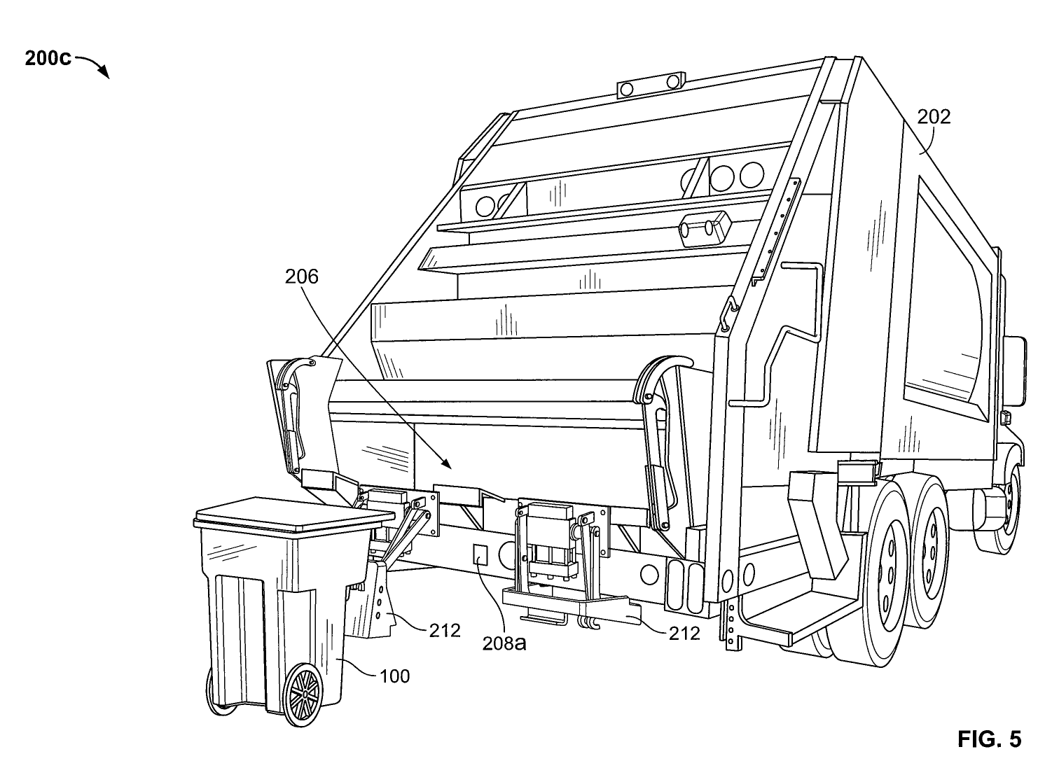

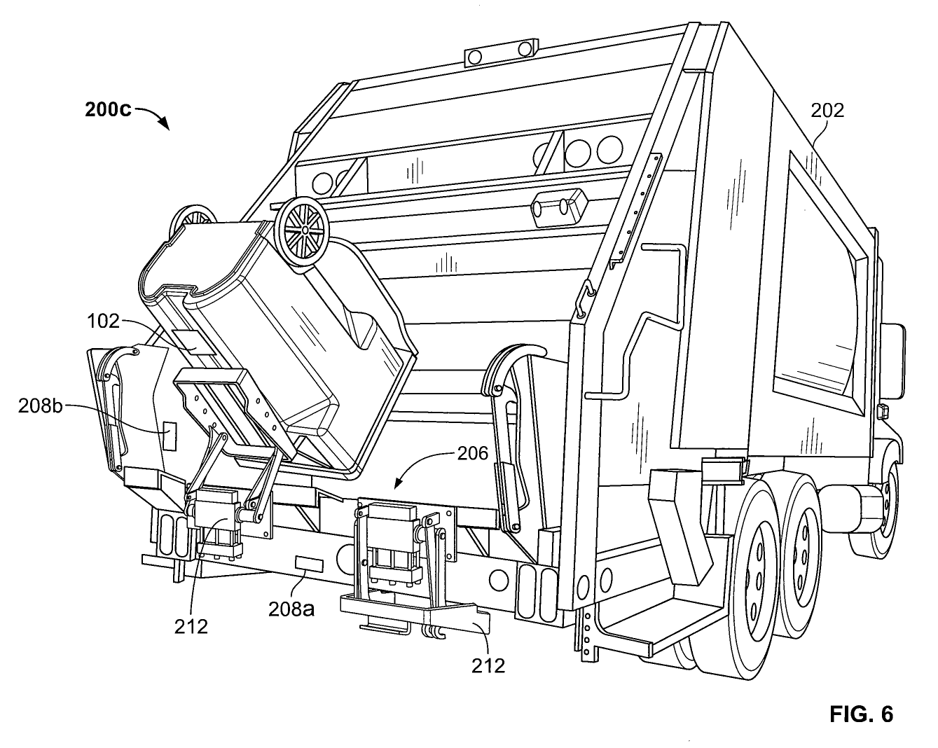

The preferred location of the first receiver 208a on a rear loading vehicle 200c, illustrated in FIGS. 5 and 6, is at the rear of the vehicle 200c above the baseline, between the tail lights, but below the emptying site 206. Thus, as receptacles 100 are transported to the vehicle 200c for emptying at the emptying site 206, the communication means 102 may be positioned such that the first receiver 208a may receive the signal from the communication means 102 without difficulty. These types of vehicles 200c may or may not be outfitted with an automated means for transferring receptacle 212. The example shown in the drawings exhibits such an automated system.

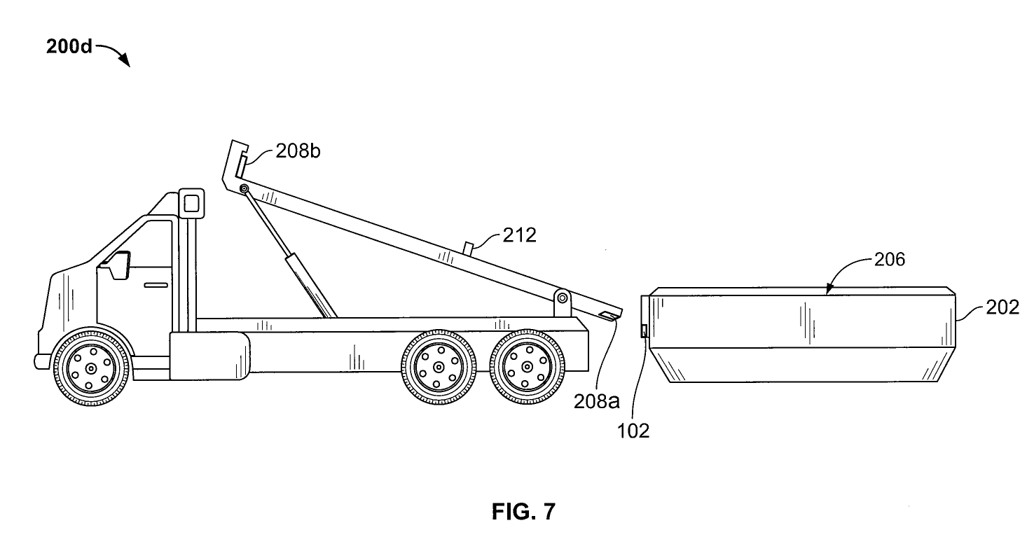

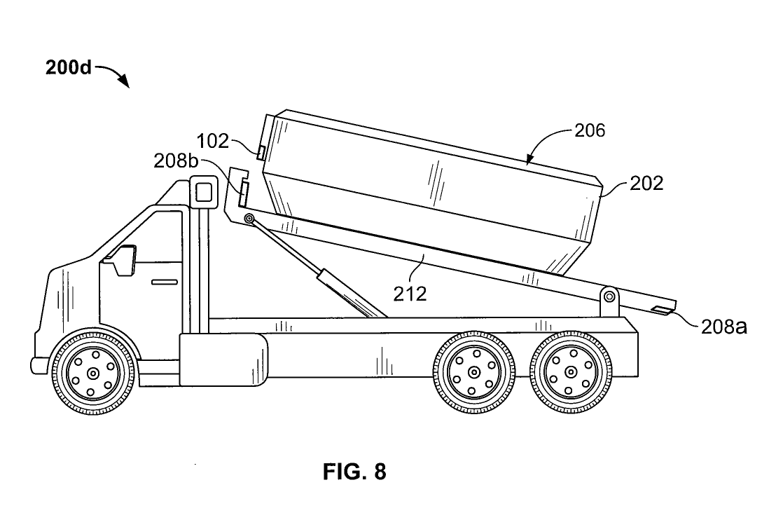

The preferred location of the first receiver 208a on a roll-off vehicle 200d, illustrate in FIGS. 7 and 8, is similar to the location on rear loading vehicles 200c, namely at the rear of the vehicle 200d, above the baseline and between the tail lights of the vehicle 200d where the means for transferring 212 first engages the waste bin 202. Although one of ordinary skill in the art would readily recognize this point, it should be noted that a roll-off vehicle 200d differs from the other vehicles 200a-c in that the waste bin 202 also acts as the receptacle. Thus, the transfer means 212 does not transfer and dump a receptacle. Rather, it engages a waste bin 202 and loads it onto the vehicle 200d bed. It follows that the transmitter means 102 would be located on the waste bin 202, preferably on the forward or front facing wall as shown in the drawings.

The vehicles 200a-d also include a second receiver 208b located at a position where reception of the signal from the transmitter means 102 can be promoted either at the instant of receptacle unloading or just prior or just subsequent to receptacle unloading. Accordingly, this second location is typically adjacent the emptying site 206 to the chamber 204 and in alignment with the first receiver. The phrases “in alignment with the first receiver 208a,” “aligned with the first receiver 208a,” and the like are intended to include a position wherein a path of the receptacle and the means for transmitting 102 taken from the first position at the first receiver 208a to a second position at the second receiver 208b, as determined by the means for transferring the receptacle 212 included on the vehicles 200a-c, naturally brings the means for transmitting 102 to a location where the second receiver 208b can receive the signal from the means for transmitting 102, i.e. into a range of the second receiver 208b where reception is achieved.

The preferred location of the second receiver 208b on a front loading vehicle 200a, illustrated in FIGS. 1 and 2, is on the front of the vehicle 200a above the windshield and preferably above the cab, approximately aligned with the first receiver 208a. The second receiver 208b may be attached to the roof of the cab or closer to the emptying site 206, which is an opening on the vertically upper surface of the bin 202, on a portion of the bin 202 just behind the cab and aligned with the first receiver 208a. The second receiver 208b may be located within or protected by the shell of the vehicle 200a or the bin 202 as long as the receiver 208b is capable of achieving its purpose.

The preferred location for the second receiver 208b on a side loading vehicle 200b, illustrated in FIGS. 3 and 4, is on a side of the vehicle corresponding to a side of the vehicle where the receptacle 100 would be located and elevated above the position of the first receiver 208a. This location is typically on the passenger side either just behind the cab or on the cab to the rear of the passenger side door, either on the roof of the cab, on the rear of the cab adjacent the roof, or on some other portion of the vehicle 200b, such as an upper, stationary portion of the transfer means 212 as illustrated. In any case, the second receiver 208b is aligned with the first receiver 208a as determined by the path of the receptacle 100 provides by the means for transferring the receptacle 212.

The preferred location of the second receiver 208b on a rear loading vehicle 200c, illustrated in FIGS. 5 and 6, is at the rear of the vehicle 200c above the baseline, between the tail lights, and above the first receiver site 208a and aligned therewith.

The preferred location of the second receiver 208b on a roll-off vehicle 200d, illustrate in FIGS. 7 and 8, is generally some portion of the vehicle 200d adjacent to where the front face of the bin 202 having the transmitter means 102 is located once the bin 202 is loaded onto the vehicle 200d. This may be on the back of the cab adjacent to where the means for transmitting 102 on the waste bin 202 is positioned once the transfer means 212 positions the waste bin 202 on the vehicle 200d, or it may be on a forward portion of transfer means 212 as illustrated. Again, the second receiver 208b is preferably aligned with the first receiver 208a.

As shown in the block diagram of FIG. 16, the vehicle 200 has a controller 214, for activating and deactivating the means for transferring the receptacle 212, in communication with an on-board computer 216. The on-board computer 216 has a graphic interface 218 and provides the data or communication link to the external site 300 via modem or some other communication device. The controller 214 may also be a module within the on-board computer without departing from the spirit of the invention. Communication to and from the external site 300 is shown as wireless communication. The first and second receivers 208a,b are illustrated as spaced wherein as the transmitting means 102 traverses toward the first receiver 208a, the first receiver 208a receives the signal from the transmitter means 102. Likewise, as the receptacle 100 is transferred to the second position where the second receiver 208b is located, the second receiver 208b receives the signal from the transmitter means 102. Movement of the receptacle 100 and the associated signal are shown in dashed lines.

The external site 300 may include a server 302 in communication with computer 304 and a database 306, typically on the computer 304. Of course, the server 300 is not required to be at the same physical site as the computer 304, nor is it required for the database 306 to be stored on a computer separate from the server 302. The block diagram is merely an example of a possible layout. The only requirement for the external site 300 is the database 306 and a means for communication between the vehicles and database 306.

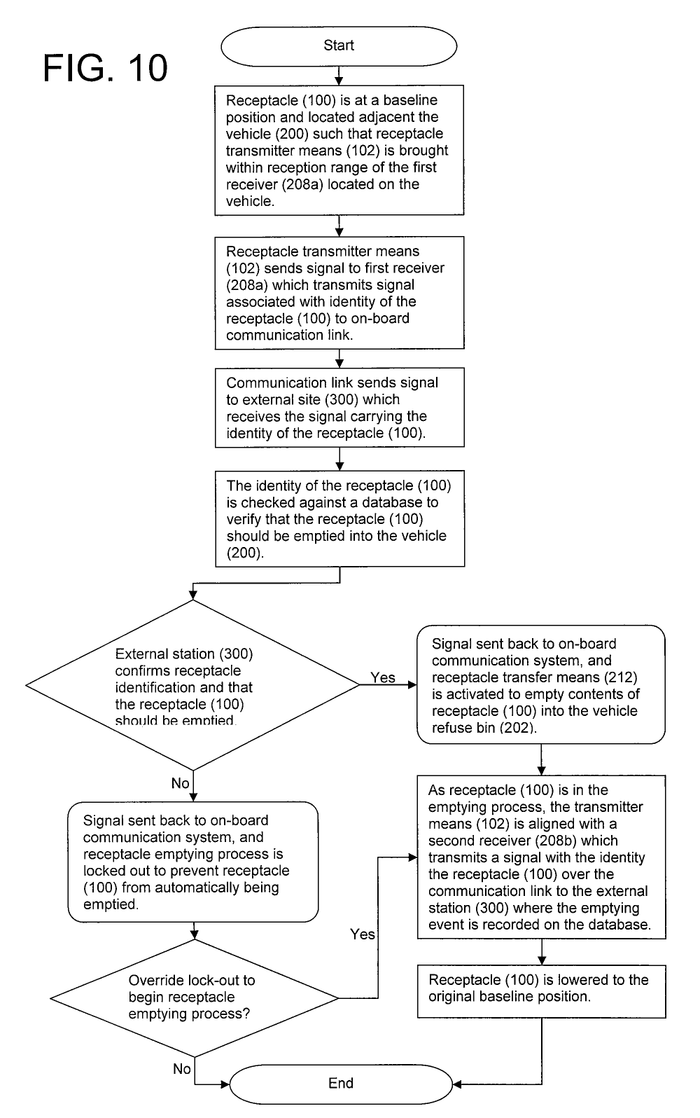

Now, as illustrated in flowcharts of FIG. 10-15, the various components of the system, the receptacle 100, the vehicle 200, and the external site 300, work together to provide an overall apparatus, the elements of which were described above, and a method for removing and hauling waste.

Referring to FIG. 10, first, a receptacle 100 is located at a baseline position adjacent the vehicle 200 such that means for transmitting 102 is brought within the reception range with the first receiver 208a. The transmitter means 208a sends a signal carrying discreet receptacle identifier information to the receiver 208a. The receiver 208a either passes the signal directly to the on-board communication link, preferably a module of the on-board computer 216, or generates a new signal based on the signal received from the means for transmitting, but still including some type of receptacle identifier.

Next, the communication link sends a signal, either pass though or new, to the external site which receives the signal. The identity of the receptacle 100 is checked against an account database 306 to verify that the receptacle 100 should be emptied into the vehicle 200. A signal is generated indicating the account status associated with the receptacle identifier.

If the account is in good standing (pass condition), the controller 214 for the means for transferring the receptacle 212 is automatically activated either by a module or routine on the on-board computer or on the external computer 304. The means for transferring the receptacle 212 transports the receptacle 100 to the emptying site 20 where the transmitter means 102 is within reception range of the second receiver 208b. The transmitter means 102 sends a signal carrying discreet receptacle identifier information to the receiver 208b. The receiver 208b either passes the signal directly to the on-board communication link, preferably a module of the on-board computer 216, or generates a new signal based on the signal received from the means for transmitting, but still including some type of receptacle identifier. The triggered or pass through signal from the second receiver 208b represents an event. The event is preferably the emptying of the receptacle 100 into the vehicle bin 202. This event is recorded on the database 306 at the external site 300 and associated with the receptacle account.

If the account is not in good standing (fail condition), the controller 214 is not activated, a signal carrying an alarm or warning is transmitted to the vehicle 200. The account status can also be displayed on the on-board graphic interface 218. As a result, the transfer means 212 is not activated, and the receptacle 100 is not emptied into the vehicle bin 202. However, if for some reason, such as immediate, on-the-spot payment of an invoice by a customer, the vehicle personnel are inclined to empty the receptacle 100, vehicle personnel may override the alert and manually engage/energize the transfer means 212. In this case, as illustrated on the right hand side of FIG. 10, transmitter means 102 sends a signal carrying discreet receptacle identifier information to the second receiver 208b. The second receiver 208b either passes the signal directly to the on-board communication link, preferably a module of the on-board computer 216, or generates a new signal based on the signal received from the means for transmitting, but still including some type of receptacle identifier. The triggered or pass through signal from the second receiver 208b represents an event. The event is preferably the emptying of the receptacle 100 into the vehicle bin 202. This event is recorded on the database 306 at the external site 300 and associated with the receptacle account. The first receiver 208a may send an additional signal at a second moment in time when the receptacle 100 at is returned to the first position.

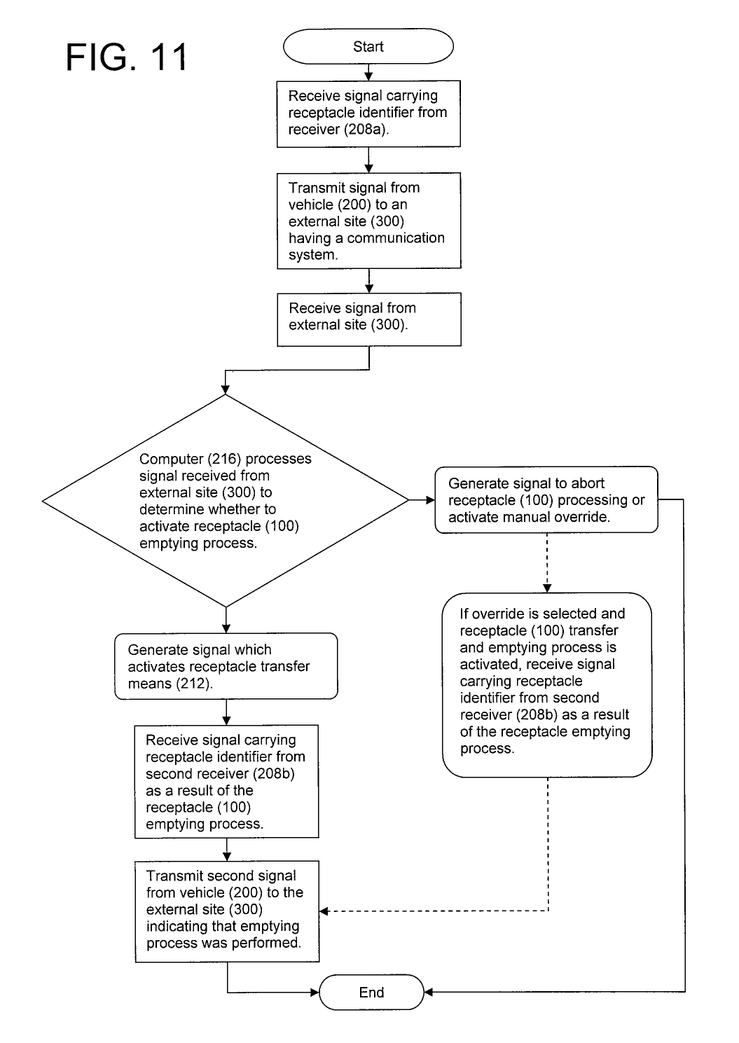

Referring specifically to FIG. 11, a flowchart of a process of the on-board computer 216 is illustrated. Here, the communication or data link between the receivers 208a,b and the external site 300 is a module or routine provided by the computer 216. This process comprises receiving a signal carrying the receptacle identifier from the first receiver 208a. The computer 216 then transmits a signal from the vehicle 200 to the external site 300. Once the data has been analyzed at the external site 300, the computer 216 receives a return signal from the external site 300 and determines whether to activate the transfer means 212 or require an override to empty the receptacle 100. If the transfer means 212 is activated, either automatically or manually via override, the second receiver 208b will send a signal to the computer 216. The computer 216 transmits a second signal to the external site 300 indicating that the emptying event has taken place.

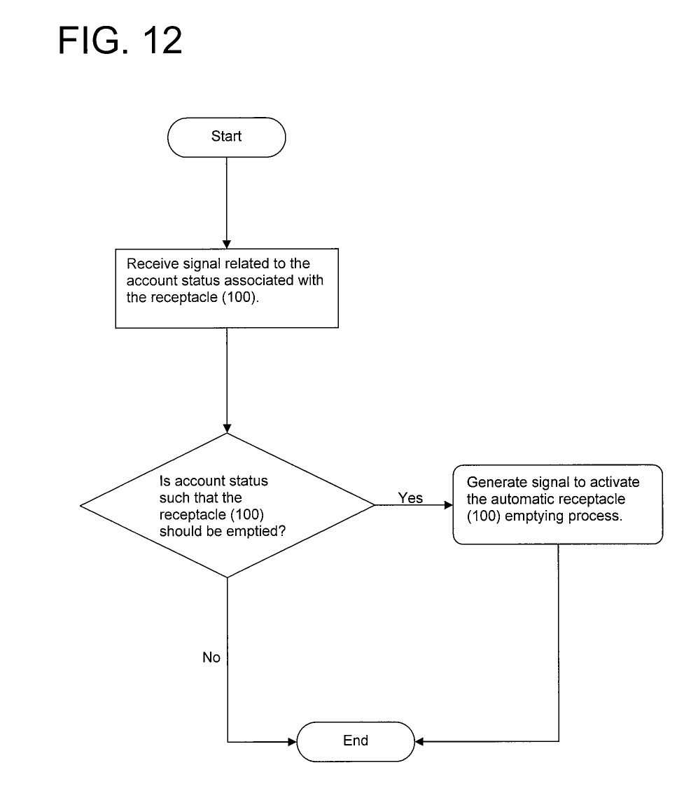

Referring specifically to FIG. 12, a process for controlling the transfer means 212 is illustrated. This process may be performed by the on-board computer 216 or by an existing controller 214 in communication with the on-board computer 216. The computer 216 receives a signal related to or determined by an account status associated with the receptacle. If the account status is such that the receptacle should be emptied, i.e. current, a signal is generated to automatically energize the transfer means 212. If the account status is not current, the process ends.

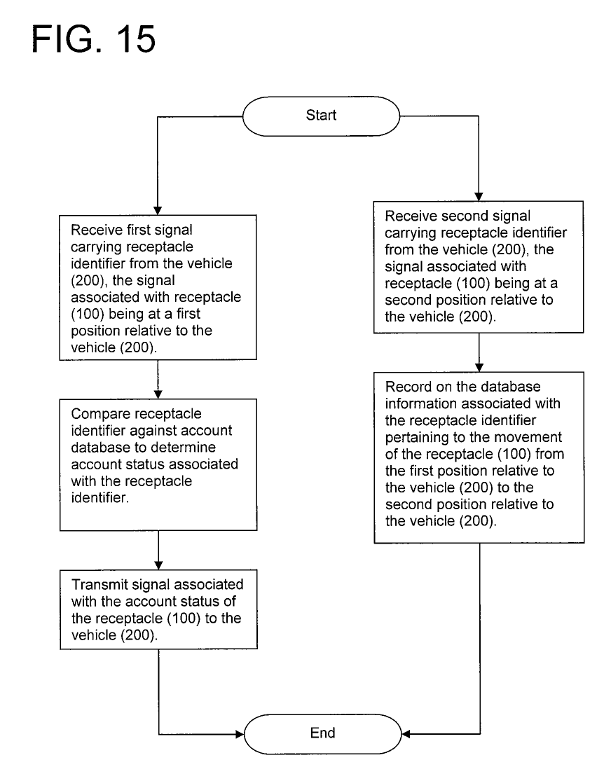

Referring to FIG. 15, a process of the computer 304 of the external site 300 is illustrated. The main purpose of the server 302 and/or the computer 304 of the external site 300 is to hold or have the capability of accessing a database 306, the database 306 including an association between receptacle identity, ownership or responsibility, and account status. In terms of the overall system or method of the invention, the external site 300 communicates with the vehicle 200 by receiving and sending signals.

For example, the external site 300 receives a first signal carrying a receptacle identifier from the vehicle 200. This first signal is associated with the receptacle 100 being located at the first position. The first signal originates with, though is not necessarily identical to, the signal received from the transmitter means 102 at the first receiver 208a. A module at the external site 300, preferably on the computer 304, compares the data carried by the signal against account information on the database 306 to determine an account status associated with the receptacle identifier. The result of the comparison, i.e. the account status, is transmitted from the external site 300 back to the vehicle.

Further, the external site 300 receives a second signal from the vehicle 200. This second signal is associated with the receptacle 100 being located at the second position. The second signal originates with, though is not necessarily identical to, the signal received from the transmitter means 102 at second receiver 208b. A module at the external site 300, preferably on the computer 304, compares the data carried by the signal against account information on the database 306 and records an event, the emptying of the receptacle 100, in connection with the receptacle 100.

While the specific embodiments have been illustrated and described, numerous modifications come to mind without significantly departing from the spirit of the invention, and the scope of protection is only limited by the scope of the accompanying Claims.

What is claimed is:

1. An apparatus for removing and hauling waste, the apparatus comprising:
a waste receptacle having a signal generating means for generating a data carrying signal associated with an identity of the waste receptacle;
a vehicle comprising a first receiver, a waste bin located above a baseline, and a data link, the first receiver alignable with the signal generating means for receiving the data carrying signal from the waste receptacle, the waste bin having a chamber and an emptying site wherein the data link receives the data signal from the first receiver and transmits a first signal from the vehicle to an external location; and
an external site at the external location in communication with the data link for receiving the first signal from the vehicle and transmitting a second signal back to the vehicle regarding an account status associated with the waste receptacle.

2. The apparatus of claim 1 further comprising:
a graphic interface on the vehicle for displaying the account status associated with the waste receptacle.

3. The apparatus of claim 2 further comprising:
a second receiver on the vehicle; and
a waste receptacle transfer means on the vehicle driven from a first position associated with the baseline to a second position associated with the emptying site of the waste bin and back to the first position, wherein the waste receptacle is temporarily retainable to the waste receptacle transfer means and transferrable by the waste receptacle transfer means from the first position to the second position to empty a contents of the waste receptacle into the waste bin at the emptying site and back to the first position wherein the second receiver is associated with the second position and alignable with the signal generating means for receiving the data carrying signal from the waste receptacle wherein the data link is further for receiving the data signal from the second receiver and transmitting a second signal from the vehicle to the external site.

4. The apparatus of claim 3 further comprising:
an on-board controller in communication with the external site for receiving a signal from the external site regarding an account status associated with the waste bin wherein the on-board controller allows either movement of the waste receptacle transfer means to move the waste receptacle from the first position to the second position upon receipt of a pass condition signal or locks out movement of the waste receptacle transfer means upon a receipt a fail condition signal.

5. An apparatus for removing and hauling waste, the apparatus comprising:
a first receiver transmitting a first signal carrying an identifier associated with a waste receptacle at a first instant in time;
a data link receiving the first signal carrying the identifier associated with the waste receptacle and transmitting a first signal associated with the identifier to an external location;
a graphic interface displaying information received pertaining to the waste receptacle from the external location; and
a second receiver spaced apart from the first receiver transmitting a second signal carrying an identifier associated with a waste receptacle at a second instant in time after some duration from the first instant time wherein the data link receives the second signal carrying the identifier associated with the waste receptacle and transmits a second signal associated with the identifier to an external location indicating a physical transport of the waste receptacle from proximate the first sensor to proximate the second sensor.

6. The apparatus of claim 5 further comprising:
a controller in communication with the data link for preventing physical transport of the waste receptacle from proximate the first sensor to proximate the second sensor in response to a signal received from an external site regarding an account status associated with the waste receptacle.

7. A method for removing and hauling waste, the method comprising the steps of:
providing a first receiver at a mobile first location;
receiving a signal carrying an identifier associated with a waste receptacle using the first receiver;
providing a data link at the mobile first location to transmit a first data signal carrying waste receptacle identifying information from the mobile first location to a discreet second location and for receiving signals from the discreet second location; and
providing a graphic interface at the mobile first location to convey account information associated with waste receptacle from the discreet second location.

8. The method of claim 7 further comprising the steps of:
providing a second receiver spaced apart from the first receiver at the mobile first location; and
receiving the signal carrying an identifier associated with a waste receptacle using the second receiver.

9. The method of claim 8 further comprising the step of:
transmitting a second data signal carrying waste receptacle identifying information from the mobile first location to the discreet second location.

10. The method of claim 9 further comprising the step of:
automatically controlling physical movement of the waste receptacle from a position proximate the first receiver to a position proximate the second receiver based on a signal received from the external location in response to the first data signal.

11. The method of claim 10 further comprising the step of:
providing a radio frequency generating device attachable to the waste receptacle for generating the signal carrying an identifier associated with the waste receptacle.

12. The method of claim 11 further comprising the step of:
providing a module located at the external location for processing the first and second data signals.

13. The method of claim 12 further comprising the step of:
comparing the first data signal against an account database associated with the waste receptacle using the module.

14. The method of claim 13 further comprising the step of:
generating a return signal communicating an account status associated with the waste receptacle based on the comparison of the first data signal against the account database.

15. The method of claim 14 further comprising the step of:
transmitting the return signal to the mobile location.

16. The method of claim 15 further comprising the step of:
storing a value in the account database associated with a physical movement of the waste receptacle from the position proximate the first receiver to the position proximate the second receiver.

17. The method of claim 16 further comprising the step of:
providing a waste hauling vehicle to which the first and second receivers are fixedly attached.

18. The method of claim 17 further comprising the steps of:
providing a waste bin on the waste hauling vehicle, the waste bin located above a baseline and having a chamber and an emptying site; and
providing a waste bin transfer means driven from a first position associated with the baseline to a second position located above the baseline on the vehicle, wherein the waste bin is temporarily retainable to the waste bin transfer means and transferrable by the waste bin transfer means from the first position to the second position to fix the waste bin at the second position on the vehicle for transporting the waste bin to a new location.

19. A method for removing and hauling waste, the method comprising the steps of:
receiving a signal carrying identifying information from a waste receptacle outfitted with a signal generating means at a first location;
transmitting the signal carrying identifying information from the first location to a data link;
transmitting a first data signal carrying information regarding the identity of the waste receptacle to an external site;
comparing the first data signal against an account information associated with the waste receptacle;
transmitting a return data signal having a value designating an account status associated with the waste receptacle from the external site;
automatically triggering physical movement of the waste receptacle based on the value received from the external site;
receiving the signal carrying identifying information from a waste receptacle outfitted with a signal generating means at a second location;
transmitting the signal carrying identifying information from the second location to the data link;
transmitting a second data signal carrying information regarding the identity of the waste receptacle to the external site; and
storing data gleaned from the second data signal in the account information associated with the waste receptacle.

20. A method for a municipality to control, track, and monitor waste or refuse receptacles, the method comprising the steps of:
requiring a permit for use of a waste receptacle;
issuing the permit associated with a discreet receptacle identifier;
providing a transmitter means attached to a discreet receptacle; and
transmitting a signal carrying data associated with the discreet receptacle identifier from the transmitter means.

21. The method of claim 20 further comprising the step of:
providing a handheld receiver for receiving the signal from the transmitter means.

22. The method of claim 21 further comprising the steps of:
identifying a municipal code violation associated with a use of the waste receptacle; and
using the handheld receiver to automatically generate citations based on the municipal code violation.
